(19) United States
(12) Patent Application Publication
(10) Pub. No.: US 2009/0256796 A1
(43) Pub. Date: Oct. 15, 2009

(54) DISPLAY DEVICE AND METHOD OF MANUFACTURING THE SAME

(75) Inventors: Jae-Woo Jang, Suwon-si (KR); Young-Jae Lee, Yongin-si (KR); Jin-Ho Cho, Cheonan-si (KR); Chul-Woo Lee, Asan-si (KR); Jong-Young Yun, Seoul (KR); Neung-Beom Lee, Asan-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/365,405

(22) Filed: Feb. 4, 2009

(30) Foreign Application Priority Data
Apr. 15, 2008 (KR) 1020080034703

(51) Int. Cl. G09G 3/36; G02F 1/1339

(52) U.S. Cl. 345/102; 349/190

(57) ABSTRACT

A display device includes a backlight assembly, a display panel, a top chassis and a sealing member. The backlight assembly includes a light-generating unit, a receiving container receiving the light-generating unit and a mold frame disposed along an edge portion of the receiving container. The display panel is disposed on the mold frame. The top chassis is coupled to the receiving container, covers an edge portion of the display panel and fixes the display panel by. The sealing member is disposed between the mold frame and the top chassis to surround an end portion of the display panel, such as to fully seal a space between the end portion of the display panel and the mold frame. The sealing member has elasticity, insulating properties and adsorption capacity for foreign matter.

This application claims priority to Korean Patent Application No. 2008-34703 filed on Apr. 15, 2008, and all the benefits accruing under 35 U.S.C. § 119, the contents of which are herein incorporated by reference in their entirety.

### BACKGROUND OF THE INVENTION

1. Field of the Invention

The present invention relates to a display device and a method of manufacturing the display device. More particularly, the present invention relates to a display device displaying images by using light transmittance of liquid crystal and a method of manufacturing the display device.

2. Description of the Related Art

A liquid crystal display (“LCD”) device displays images using liquid crystal that has optical characteristics such as anisotropy of refractivity and electrical characteristics such as anisotropy of dielectric constant. The LCD device includes an LCD panel displaying images using optical transmittance of liquid crystal molecules and a backlight assembly disposed below the LCD panel to provide light to the LCD panel.

The LCD panel includes a first substrate, a second substrate and a liquid crystal layer interposed between the first substrate and the second substrate. The first substrate includes a thin-film transistor (“TFT”) and a pixel electrode electrically connected to the TFT. The second substrate includes a color filter in correspondence with the pixel electrode and a common electrode formed on a whole surface of a substrate.

The backlight assembly includes a light-generating unit generating light, a receiving container receiving the light-generating unit and a mold frame disposed along an edge portion of the receiving container to support the LCD panel.

The LCD device further includes a top chassis which covers an edge of the LCD panel to be coupled with the receiving container to fix the LCD panel.

The LCD device is generally disposed indoors to display images. However, the LCD device has recently been disposed outdoors to display images. That is, the LCD device may be disposed outdoors where foreign matter such as fine particles are included.

### BRIEF SUMMARY OF THE INVENTION

Since an LCD device includes the top chassis coupled to the receiving container, and the mold frame disposed along an edge portion of the receiving container to support the LCD panel, there may be undesirable consequences in disposing the LCD device outdoors where the foreign matter is included. For example, the foreign matter may flow into an inner space of the receiving container through a space between the mold frame and the top chassis. Consequently, the foreign matter flowing into the receiving container may undesirably reduce the display quality of the images.

Exemplary embodiments of the present invention provide a display device capable of reducing or effectively preventing foreign matter, such as fine particles, from flowing into an inner space thereof.

Exemplary embodiments of the present invention provide a method of manufacturing the above-mentioned display device.

In an exemplary embodiment, a display device includes a backlight assembly, a display panel, a top chassis and a sealing member. The backlight assembly includes a light-generating unit generating light, a receiving container receiving the light-generating unit and a mold frame disposed along an edge portion of the receiving container. The display panel is disposed on the mold frame to display images by using the light. The top chassis is coupled to the receiving container to cover an edge portion of the display panel and to fix the display panel. The sealing member is disposed between the mold frame and the top chassis to surround an end portion of the display panel to fully seal a space between the end portion of the display panel and the mold frame. The sealing member has elasticity, insulating properties and adsorption capacity for foreign matter.

In an exemplary embodiment of the present invention, the mold frame may include a mold bottom part and a mold side part. The mold bottom part is disposed substantially in parallel with a lower surface of the display panel facing the receiving container to support the display panel. The mold side part is extended from the mold bottom part to face the end portion of the display panel.

In an exemplary embodiment of the present invention, the sealing member may fully seal a space between the end portion of the display panel and the mold side part. The sealing member may contact the end portion of the display panel and an edge portion of a lower surface of the display panel. The sealing member may contact the end portion of the display panel and an edge portion of an upper surface of the display panel. Alternatively, the sealing member may contact the end portion of the display panel, an edge portion of a lower surface of the display panel, and an edge portion of an upper surface of the display panel.

In an exemplary embodiment of the present invention, the sealing member may include a lower sealing part and an upper sealing part. The lower sealing part may contact the end portion of the display panel and an edge portion of a lower surface of the display panel. The upper sealing part may contact the end portion of the display panel and an edge portion of an upper surface of the display panel. The lower sealing part seals a space between the mold bottom part and a lower surface of the display panel, and the upper sealing part seals a space between the top chassis and an upper surface of the display panel.

In an exemplary embodiment of the present invention, the sealing member may include a silicon material. Alternatively, the sealing member may include a plastic material having high elasticity.

In an exemplary embodiment of the present invention, the display device may further include a panel-supporting part disposed on the mold bottom part to contact a lower surface of the display panel, the panel-supporting member having elasticity to support the display panel.

In an exemplary embodiment of the present invention, the display device may further include a panel-pressing part disposed on an inner side surface of the top chassis. The panel-pressing part may have elasticity to press the display panel. The panel-pressing part may include a conductive material to emit static electricity of the display panel.

In an exemplary embodiment, there is provided a method of manufacturing a display device. In the method, a backlight assembly is manufactured, which includes a light-generating unit generating light, a receiving container receiving the light-generating unit and a mold frame disposed along an edge portion of the receiving container. A sealing member is disposed on at least one of the mold and a top chassis, which will be coupled to the receiving container. A display panel displaying images is disposed on the mold frame. The top chassis is coupled with the receiving container, such that the sealing member surrounds an end portion of the display panel and fixes the top chassis to the display panel.

In an exemplary embodiment of the present invention, the mold frame may include a mold bottom part and a mold side part. The mold bottom part may be formed substantially in parallel with a lower surface of the display panel facing the receiving container to support the display panel. The mold side part may be extended from the mold bottom part to face the end portion of the display panel. The sealing member may fully seal a space between the end portion of the display panel and the mold side part after the top chassis is coupled to the receiving container.

In an exemplary embodiment of the present invention, the forming a sealing member may include disposing the sealing member on the mold bottom part. The sealing member may have a protruding shape protruded toward the top chassis to fully seal a space between the end portion of the display panel and the mold side part. Alternatively, the forming a sealing member may include disposing the sealing member on an inner side surface of the top chassis. The sealing member may have a protruding shape protruded toward the receiving container to be fully seal a space between the end portion of the display panel and the mold side part.

In an exemplary embodiment of the present invention, the sealing member may include a lower sealing part formed on the mold bottom part, and an upper sealing part formed on an inner side surface of the top chassis to correspond with the lower sealing part.

In an exemplary embodiment, there is provided a method of manufacturing a display device. In the method, a backlight assembly is manufactured, which includes a light-generating unit generating light, a receiving container receiving the light-generating unit and a mold frame disposed along an edge portion of the receiving container. A display panel displaying images is disposed on the mold frame. A sealing member is disposed on the mold frame to surround an end portion of the display panel. A top chassis is coupled with the receiving container to fix the display panel.

In an exemplary embodiment of the present invention, the mold frame may include a mold bottom part and a mold side part. The mold bottom part may be disposed substantially in parallel with a lower surface of the display panel facing the receiving container to support the display panel. The mold side part may be extended from the mold bottom part to face the end portion of the display panel. The sealing member fully seals a space between the end portion of the display panel and the mold side part after the top chassis is coupled to the receiving container.

In an exemplary embodiment of the present invention, the sealing member is disposed between the mold frame and the top chassis to surround an end portion of the display panel, so as to fully seal a space between the end portion of the display panel and the mold side part. Advantageously, entering of foreign matter such as fine particles between the mold frame and the top chassis may be reduced or effectively prevented.

### BRIEF DESCRIPTION OF THE DRAWINGS

The above and other features and advantages of the present invention will become more apparent by describing in detailed exemplary embodiments thereof, with reference to the accompanying drawings.

FIG. 1 is a perspective view illustrating an exemplary embodiment of a display device according to the present invention;

FIG. 2 is a cross-sectional view taken along line I-I′ of FIG. 1;

FIG. 3 is an enlarged cross-sectional view illustrating portion “A” in FIG. 2;

FIG. 4 is a cross-sectional view illustrating an exemplary embodiment of a process for manufacturing a display device of FIG. 2;

FIG. 5 is a partial cross-sectional view illustrating another exemplary embodiment of a display device according to the present invention;

FIG. 6 is a cross-sectional view illustrating an exemplary embodiment of a process for manufacturing the display device of FIG. 5;

FIG. 7 is a partial cross-sectional view illustrating another exemplary embodiment of a display device according to the present invention;

FIG. 8 is a cross-sectional view illustrating an exemplary embodiment of a process for manufacturing the display device of FIG. 7;

FIG. 9 is a partial cross-sectional view illustrating another exemplary embodiment of a display device according to the present invention; and

FIG. 10 is a cross-sectional view illustrating an exemplary embodiment of a process for manufacturing the display device of FIG. 9.

### DETAILED DESCRIPTION OF THE INVENTION

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “below,” “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “lower” relative to other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-sectional illustrations that are schematic illustrations of idealized exemplary embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be explained in detail with reference to the accompanying drawings.

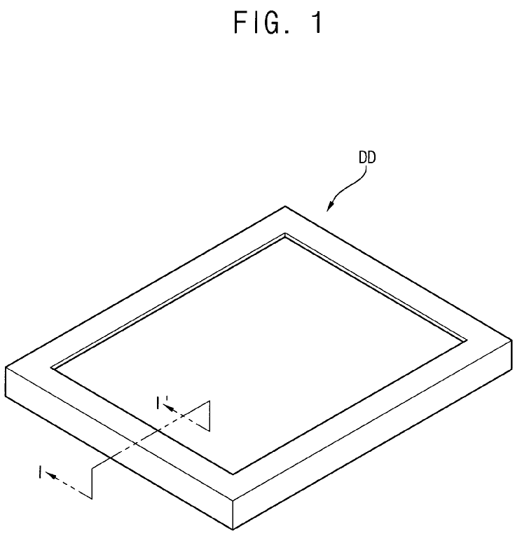

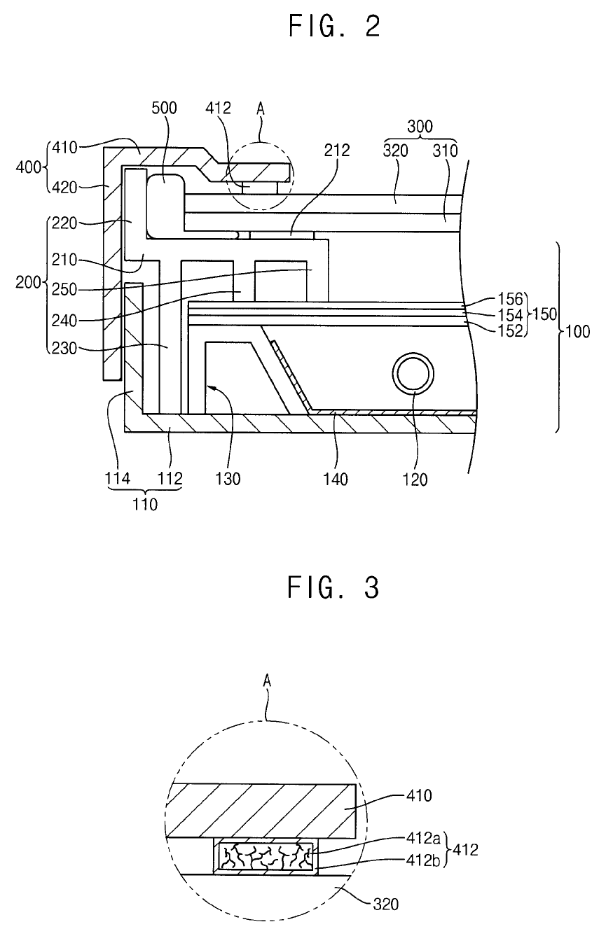

FIG. 1 is a perspective view illustrating an exemplary embodiment of a display device according to the present invention. FIG. 2 is a cross-sectional view taken along line I-I′ of FIG. 1. FIG. 3 is an enlarged cross-sectional view illustrating portion “A” in FIG. 2.

Referring to FIGS. 1 to 3, a display device DD includes a backlight assembly 100, a display panel 300, a top chassis 400 and a sealing member 500.

The backlight assembly 100 generates light to provide the light to the display panel 300 with the light. The backlight assembly 100 includes a receiving container 110, a light-generating unit 120 and a mold frame 200. In the illustrated embodiment, the backlight assembly 100 may further include a side mold 130, a reflective plate 140 and an optical member 150.

The receiving container 110 includes a receiving bottom part 112 having a substantially plate (e.g., planar) shape, and a receiving side part 114 extended from an end or edge portion of the receiving bottom part 112. The receiving container 1 may receive the light-generating unit 120, the side mold 130, the reflective plate 140 and the optical member 150. The receiving container 1 may also be referred to as a bottom chassis.

The light-generating unit 120 is received in the receiving container 110 and generates light. In exemplary embodiments, the light-generating unit 120 may be a cold cathode fluorescent lamp (“CCFL”) having a bar shape or a U-shape. Alternatively, the light-generating unit 120 may be a light-emitting diode (“LED”) generating light of a point shape.

The side mold 130 is received in the receiving container 110 and disposed adjacent to the receiving side part 114. The side mold 130 may have a U-shape, and a portion of the side mold 130, such as a vertical portion, may be disposed substantially parallel with the receiving side part 114. As illustrated in FIG. 2, an end portion of the side mold 130 may be substantially coplanar with the receiving bottom part 112. An inclined portion of the side mold 130 may be inclined with respect to a plane of the receiving bottom part 112 toward the receiving side wall 114. The inclined portion of the side mold 130 may extend from a substantially horizontal portion of the side mold 130 towards the receiving bottom part 112. Distal end portions of the vertical portion and the inclined portion of the side mold 130 may be referred to as substantially coplanar with an upper surface of the receiving bottom part 112.

The reflective plate 140 is disposed on the receiving bottom part 112, such as directly on and contacting the upper surface of the receiving bottom part 112. The reflective plate 140 reflects the light from the light-generating unit 120 emitted toward the receiving container 112, and provides the light in a direction toward the display panel 300. As illustrated in FIG. 2, the reflective plate 140 may be disposed on an inclined portion of the side mold 130. A portion of the reflective plate 140 may overlap an entire of or a portion of the inclined portion of the side mold 130. Alternatively, the side mold 130 and/or the receiving container 110 may include a reflective material, such that the reflective material forms a part of the receiving container 110 and the resulting reflective receiving container is a single, continuous and indivisible unit.

The optical member 150 is disposed on the light-generating unit 120 to enhance optical properties of light generated from the light-generating unit 120. The light-generating unit 120 may be disposed on a top end portion of the side mold 130. As illustrated in FIG. 2, peripheral edges of the optical member 150 may be referred to as disposed directly on and contacting an uppermost surface of the side mold 130, where the uppermost surface of the side mold 130 is substantially parallel with the receiving bottom portion 112 of the receiving container 110. The optical member 150 may include, for example, a diffusion plate 152 capable of diffusing light, and a plurality of prism sheets 154 and 156 capable of increasing a front luminance of the light.

The mold frame 200 may be disposed on the receiving container 110 along an edge portion of the receiving container 110, such as directly adjacent to the receiving side part 114 of the receiving container 110. The mold frame 200 may include a mold bottom part 210 and a mold side part 220. The mold bottom part 210 may be extended substantially in parallel with the receiving bottom part 112. The mold side part 220 may be extended from an end or edge portion of the mold bottom part 210 in a direction opposite to the receiving container 110, such as towards a front or viewing side of the display device DD. As illustrated in FIG. 2, the mold side part 220 may be disposed substantially parallel with the receiving side part 114 of the receiving container 110, and outer surfaces of the mold side part 220 and the receiving side part 114 adjacent to the top chassis 400 may be disposed substantially coplanar with each other.

The mold frame 200 may further include a first protruding part 230, a second protruding part 240 and a third protruding part 250, which may be all protruded from the mold bottom part 210, such as from a same lower surface of the mold bottom part 210 as illustrated in FIG. 2.

The first protruding part 230 may be protruded from the mold bottom part 210 toward the receiving container 110 and contact the receiving bottom part 112, such as the upper surface of the receiving bottom part 112. The first protruding part 230 may be disposed between the side mold 130 and the receiving side part 114, and be disposed substantially parallel with the receiving side part 114 and/or the vertical portion of the side mold 130. A portion of the first protruding part 230 may be referred to as disposed directly adjacent to and between the receiving side part 114 of the receiving container 110 and the vertical portion of the side mold 130.

The second protruding part 240 may be protruded from the mold bottom part 210 toward the receiving container 110 and contact the optical member 150, such as the uppermost surface of the optical member 150. When the second protruding part 240 presses a portion of the optical member 150 corresponding to an upper end surface of the side mold 130, the second protruding part 240 fixes the optical member 150.

The third protruding part 250 may be protruded from the mold bottom part 210 toward the receiving container 110, and be disposed directly adjacent to the second protruding part 240. The third protruding part 250 is disposed opposite to the mold side wall 220 relative to the first protruding part 230 and the second protruding part 240. The third protruding part 250 may directly contact the uppermost surface of the optical member 150, likewise to the second protruding part 240.

The first, second and third protruding portions 230, 240 and 250 may all be disposed substantially parallel to each other, and with the mold side part 220. The first protruding portion 230 extends further from the mold bottom part 210 than both the second and third protruding portions 240 and 250. Distal ends of the second and third protruding portions 240 and 250 may be referred to as coplanar with each other, and with the uppermost surface of the optical member 150. As illustrated in FIG. 2, the first, second and third protruding portions 230, 240 and 250 may be disposed sequentially in that order, from an outer portion towards an inner portion of the display device DD.

The display panel 300 is disposed on the backlight assembly 100 and displays images by using light generated from the backlight assembly 100. The display panel 300 may include, for example, a first substrate 310, a second substrate 320 facing the first substrate 310, and a liquid crystal layer (not shown) interposed between the first substrate 310 and the second substrate 320.

The first substrate 310 may include a plurality of signal lines (not shown), a plurality of thin-film transistors (“TFTs”) electrically connected to the signal lines (not shown), and a plurality of pixel electrodes electrically connected to the TFTs (not shown). The second substrate 320 may include a plurality of color filters (not shown) disposed in correspondence with the pixel electrodes, and a common electrode formed on a substrate. A light transmittance of the liquid crystal layer may be alternated by an electrical field formed between the pixel electrode and the common electrode. As used herein, “corresponding” and “correspondence” may refer to an element being commensurate in dimension, positional placement, shape and/or profile to another element.

The display panel 300 is disposed on the mold bottom part 210. The display panel 300 may be substantially in parallel with the mold bottom part 210, such as with the mold bottom part 210. An end portion of the display panel 300 is disposed to face the mold side part 220. As illustrated in FIG. 2, end faces of both the first substrate 310 and the second substrate 320 face an inner face of the mold side part 220.

The display device DD of the illustrated embodiment may further include a panel-supporting part 212 disposed between the display panel 300 and the mold bottom part 210. The panel-supporting part 212 may be referred to as contacting both a lower surface of the display panel 300 and an upper surface of the mold frame 200.

The panel-supporting part 212 is attached to the mold bottom part 210 and supports the display panel 300. The panel-supporting part 212 may include a material having elasticity to reduce or effectively prevent damage to the display panel 300 caused by external impacts. In one exemplary embodiment, the panel-supporting part 212 may include a rubber having elasticity, such that the rubber deforms under force of the external impact instead of the display panel 300.

The top chassis 400 covers an edge portion of the display panel 300 and may be coupled with the receiving container 110 to fix the display panel 300 therebetween. The top chassis 400 may include a chassis covering part 410 and a chassis side part 420.

The chassis covering part 410 is extended in substantially parallel with the display panel 300 to cover the edge portion of the display panel 300. The top chassis 400 may be referred to as overlapping portions of the receiving container 100, the side mold 130 and the mold frame 200. The chassis covering part 410 may be bent or inclined toward the display panel 300.

The chassis side part 420 is extended from an end portion of the chassis covering part 410 toward the receiving container 110, such as being disposed substantially parallel to a portion of the receiving container 1 and the mold frame 200. The chassis side part 420 is coupled with the receiving side wall 114 to thereby fix the display panel 300 between the receiving container 110 and the top chassis 400. The chassis side part 420 may contact an outer side surface of the mold side part 220 and/or an outer side surface of the receiving side part 114. The chassis side part 420 may be referred to as directly adjacent to both the receiving container 110 and the mold frame 200.

The display device DD in the illustrated embodiment may further include a panel-pressing part 412 disposed between the display panel 300 and the chassis covering part 410. The panel-pressing part 412 may be referred to as directly contacting both a lower surface of the top chassis 400 and an upper surface of the display panel 300.

The panel-pressing part 412 is attached to the chassis covering part 410, such that the top chassis 400 presses the display panel 300. With this configuration, damage from external impacts to the display panel 300 may be reduced or effectively prevented. The panel-pressing part 412 may include a material having elasticity to reduce or effectively prevent the display panel 300 from being damaged by external impacts, such that the elastic material deforms under force of the external impact instead of the display panel 300. As illustrated in FIG. 3, the panel-supporting part 412 may include a supporting body 412a and a conductive member, or substance, 412b.

The supporting body 412a is disposed on the chassis covering part 410 and includes a material having elastic properties. In one exemplary embodiment, the pressing body 412a may include Styrofoam having elasticity, but the invention is not limited thereto.

The conductive substance 412b is formed at a peripheral area of the pressing body 412a and is electrically connected to the upper surface of the display panel 300 and a lower surface of the chassis covering part 410. The conductive substance 412b is disposed on all sides of the supporting body 412a, such that the conductive substance 412b may be referred to as completely surrounding, enclosing and/or contacting the supporting body 412a on all sides. The conductive substance 412b is disposed between the supporting body 412a, and both the display panel 300 and the top chassis 400. The conductive substance 412b transmits static electricity generated from the display panel 300 to the top chassis 400, so that damage by the static electricity to the display panel 300 may be reduced or effectively prevented. In an exemplary embodiment, the conductive substance 412b may include a metal fiber, but is not limited thereto.

The sealing member 500 is disposed between the mold frame 200 and the top chassis 400 to surround an end portion (e.g., outer or end faces) of the display panel 300. A first portion of the sealing member 500 may be referred to as surrounding a whole of the end faces of the first substrate 310 and the second substrate 320. The first portion of the sealing member 500 may be disposed substantially perpendicular with respect to a lower surface of the display panel 300, and substantially parallel to a portion of the receiving container 110, the mold frame 200 and the top chassis 400. The first portion of the sealing member 500 may be considered between the mold side part 220 and the bent portion of the top chassis 400. In an exemplary embodiment, the first portion of the sealing member 500 may be directly contact the mold side part 220 and/or the bent portion of the top chassis 400.

In the illustrated embodiment of FIG. 2, the sealing member 500 is disposed contacting an edge portion of a lower surface of the display panel 300. A second portion of the sealing member 500 may be disposed substantially horizontally and parallel with the lower surface of the display panel 300. The second portion extends from an end of the first portion of the sealing member 500 and overlaps a portion of the mold bottom part 210. The second portion of the sealing member 500 is continuous with the first (e.g., vertical) portion, such that the sealing member 500 is single, continuous and indivisible unit. Alternatively, the first and second portions of the sealing member 500 may not be continuous, and may not meet proximate to a corner of the first substrate 310. A distal end of the second portion of the sealing member 500 may be disposed spaced apart from and/or coplanar with, the panel supporting part 212.

As illustrated in FIG. 2, the sealing member 500 is disposed both between an end portion of the display panel 300 and the mold side wall 220, and between an edge portion of a lower surface of the display panel 300 and the mold bottom part 210. Advantageously, the sealing member 500 may fully seal a space between an end portion of the display panel 300 and the mold side part 220. Moreover, the sealing member 500 may fully seal a space between an edge portion of a lower surface of the display panel 300 and the mold bottom part 210.

The sealing member 500 may have elasticity, insulating properties and/or adsorption capacity for foreign matter such as external fine particles. In one exemplary embodiment, the sealing member 500 may include a silicon material and/or a plastic material having high elasticity.

As the sealing member 500 fully seals a space between an end portion of the display panel 300 and the mold side part 220, a flow of foreign matter, such as fine particles, may be reduced or effectively prevented from entering into the receiving container through a space between the end portion of the display panel and the mold side part.

In the illustrated embodiment, the display device DD includes a direct-type backlight assembly as shown in FIG. 2. Alternatively, the display device DD may include an edge-type backlight assembly including a light-guide plate (“LGP”) (not shown) and a light source disposed at a side surface of the LGP.

Hereinafter, an exemplary embodiment of a method for manufacturing a display device of FIG. 2 will be described.

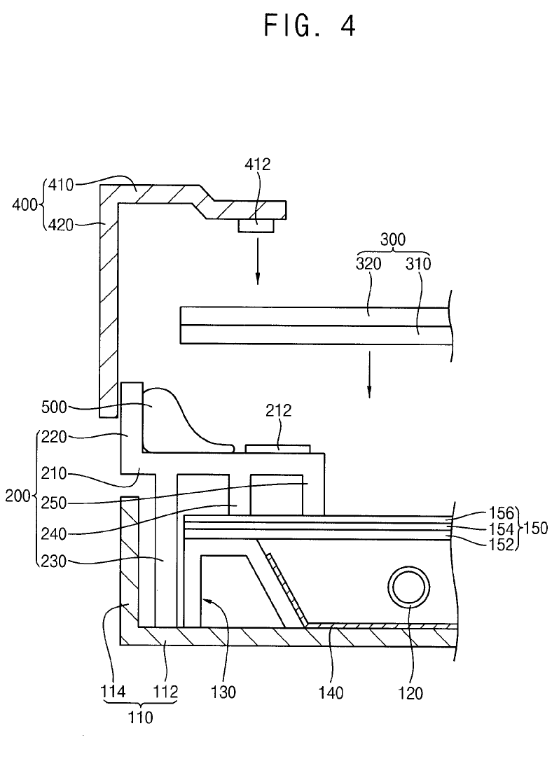

FIG. 4 is a cross-sectional view illustrating an exemplary embodiment of a process for manufacturing the display device of FIG. 2.

Referring to FIG. 4, the receiving container 110, the light-generating unit 120, the side mold 130, the reflective plate 140, the optical member 150 and the mold frame 200 are coupled with each other to manufacture the backlight assembly 100. The panel-supporting part 212 may be initially attached on the mold bottom part 210 of the mold frame 200, such that the backlight assembly 100 with the panel-supporting part 212 collectively forms a first element of the display device DD.

The sealing member 500 is disposed on the mold bottom part 210. The sealing member 500 may have an initial shape including a protruding portion protruded from an upper side of the mold bottom part 210 along the mold side part 220, while a remaining portion of the initial shape is disposed on the upper side of the mold bottom part 210.

The display panel 300 is disposed on the mold bottom part 210, as indicated by the downward pointing arrow below the display panel 300 in FIG. 4. The display panel 300 is considered a second element of the display device DD, and separate from the first element of the backlight assembly 100 with the panel-supporting part 212. The display panel 300 may contact and be supported by the panel-supporting part 212 having elasticity.

The top chassis 400 is coupled with the receiving container 110, such as indicated by the downward pointing arrow below the chassis covering part 410, and fixes the display panel 300 between the receiving container 110 and the top chassis 400. The panel-pressing part 412 may be initially attached to the chassis covering part 410 such that the top chassis 400 with the panel-pressing part 412 collectively forms a third element of the display device DD, and is considered separate from both the first and second elements of the display device DD described above.

The panel-pressing part 412 is attached on the chassis covering part 410 and presses the display panel 300 when the top chassis 400 is coupled with the receiving container 110, so that damage by external impacts to the display panel 300 may be reduced or effectively prevented. In an exemplary embodiment, the panel-pressing part 412 may include a material having elasticity in order to reduce or effectively prevent damage to the display panel 300 from the external impacts.

When the top chassis 400 is coupled with the receiving container 110, the sealing member 500 may be disposed to surround an end portion of the display panel 300. In exemplary embodiments, the contacting of the first member of the display device with the second and third members described above, may move and deform the earlier placed sealing member 500 from the initially formed shape, to be finally disposed surrounding end faces of the display panel 300, between the mold frame 200 and the top chassis 400, and between the display panel 300 and the mold frame 200. Alternatively, the initial shape of the sealing member 500 may correspond with the final desired shape the sealing member 500. Advantageously, the sealing member 500 may fully seal a space between an edge portion of the display panel 300 and the mold side part 220, and a space between an edge portion of a lower surface of the display panel 300 and the mold bottom part 210.

In the illustrated embodiments of FIGS. 1-4, as the sealing member 500 fully seals a space between an end portion of the display panel 300 and the mold side part 220, and fully seals a space between an edge portion of a lower surface of the display panel 300 and the mold bottom part 210, a flow of foreign matter such as fine particles may be reduced or effectively prevented from entering into the receiving container through a space between an end portion of the display panel 300 and the mold side part 220. The sealing member 500 may be the only member applied to the display device DD to completely seal the space between the display panel 300 and the mold frame 200. Referring to FIGS. 1 and 2, the sealing member 500 may be disposed on some or all of the four sides of the display device DD.

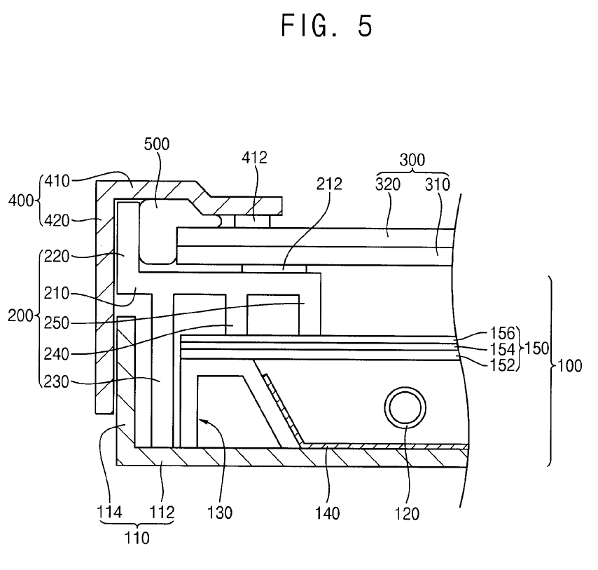

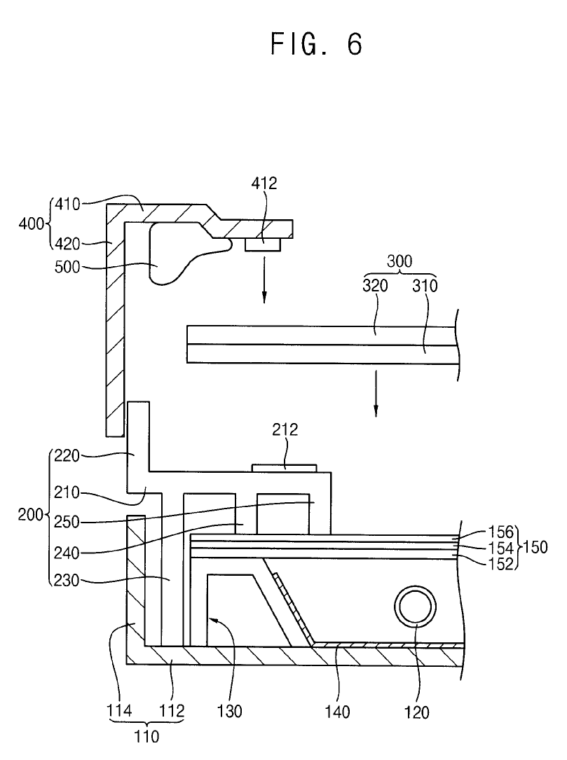

A display device in FIGS. 5 and 6 is substantially the same as the display device in FIGS. 1 to 4 except for a sealing member. Thus, identical reference numerals are used in FIGS. 5 and 6 to refer to components that are the same or like those shown in FIGS. 1 to 4, and thus, a detailed description thereof will be omitted.

FIG. 5 is a partial cross-sectional view illustrating another exemplary embodiment of a display device according to the present invention.

Referring to FIG. 5, a sealing member 500 is disposed between the mold frame 200 and the top chassis 400 to surround an end portion (e.g., end faces) of the display panel 300. The sealing member 500 may surround an entire of the end faces of both the first substrate 310 and the second substrate 320. In the illustrated embodiment, the sealing member 500 is disposed contacting the end faces of the display panel 300, and a peripheral edge portion of an upper surface of the display panel 300 which faces the chassis covering part 410.

As illustrated in FIG. 5, the sealing member 500 is disposed between an end portion of the display panel 300 and the mold side wall 220, and between an edge portion of an upper surface of the display panel 300 and a lower surface the chassis covering part 410. Advantageously, the sealing member 500 may fully seal a space between an end portion of the display panel 300 and the mold side part 220, and a space between an edge portion of an upper surface of the display panel 300 and the chassis covering part 410.

The sealing member 500 may have elasticity, insulating properties and/or adsorption capacity for foreign matter, such as external fine particles. In an exemplary embodiment, the sealing member 500 may include a silicon material and a plastic material having high elasticity.

Hereinafter, an exemplary embodiment of a method for manufacturing a display device of FIG. 5 will be described.

FIG. 6 is a cross-sectional view illustrating an exemplary embodiment of a process for manufacturing the display device of FIG. 5.

Referring to FIG. 6, the receiving container 110, the light-generating unit 120, the side mold 130, the reflective plate 140, the optical member 150 and the mold frame 200 are coupled with each other to manufacture the backlight assembly 100. The panel-supporting part 212 may be attached on a mold bottom part 210 of the mold frame 200, to form a part of a separately assembled backlight assembly 100 member.

The sealing member 500 is disposed on the chassis covering part 410, unlike the process in FIG. 4, where the sealing member 500 is initially disposed on the mold frame 200. The sealing member 500 may have an initial shape including a protruding shape protruded toward a lower side of the chassis covering part 410 along the chassis side part 420. A remaining shape of the initially shaped sealing member 500 may be positioned on a lower surface of the chassis covering part 410. The sealing member 500 may be a single, continuous and indivisible unit as shown in FIGS. 2 and 4-6. Alternatively, the sealing member 500 may include multiple parts which are combined to collectively form the sealing member 500.

The display panel 300 is disposed on the mold bottom part 210, as indicated by the downward pointing arrow below the display panel 300 in FIG. 6. The display panel 300, which may be considered a second separately assembled member, may be supported by the panel-supporting part 212 having elasticity.

The top chassis 400 is coupled with the receiving container 110, such as indicated by the downward pointing arrow below the chassis covering part 410, and fixes the display panel 300. The panel-pressing part 412 is attached on the chassis covering part 410 and presses the display panel 300, so that damage to the display panel 300 by external impacts may be reduced or effectively prevented. The top chassis 400 having the panel-pressing part 412 may be considered a third separately assembled member.

When the top chassis 400 is coupled with the receiving container 110, the sealing member 500 may be disposed to surround an end portion of the display panel 300. During the coupling of the top chassis 400 with the receiving container 110, the sealing member 500 may change from its initial shape, and be essentially molded or conformed to a combined profile of the top chassis 400, the mold frame 200 and the display panel 300, such as to result in the sealing member 500 configuration shown in FIG. 5. In exemplary embodiments, the action of the coupling of the separate elements of the display device DD may form the sealing member 500 into a final shape, or alternatively, the initial shape of the sealing member 500 may more closely resemble the final shape. Once the top chassis 400 is finally coupled to the receiving container 110, the sealing member 500 may fully seal a space between an end portion of the display panel 300 and the mold side part 220, and a space between an edge portion of an upper surface of the display panel 300 and the chassis covering part 410.

In the illustrated embodiments of FIGS. 5 and 6, as the sealing member 500 fully seals a space between an end portion of the display panel 300 and the mold side part 220, and a space between an edge portion of an upper surface of the display panel 300 and the chassis covering part 410, a flow of foreign matter such as fine particles may be reduced or effectively prevented from entering into the receiving container 110 through a space between an end portion of the display panel 300 and the mold side part 220.

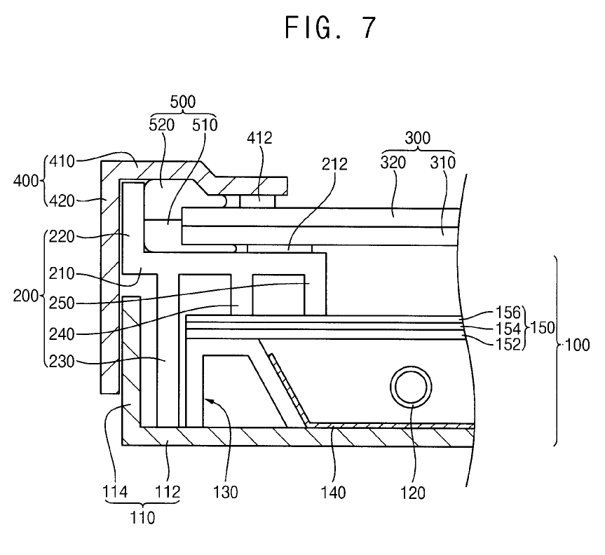

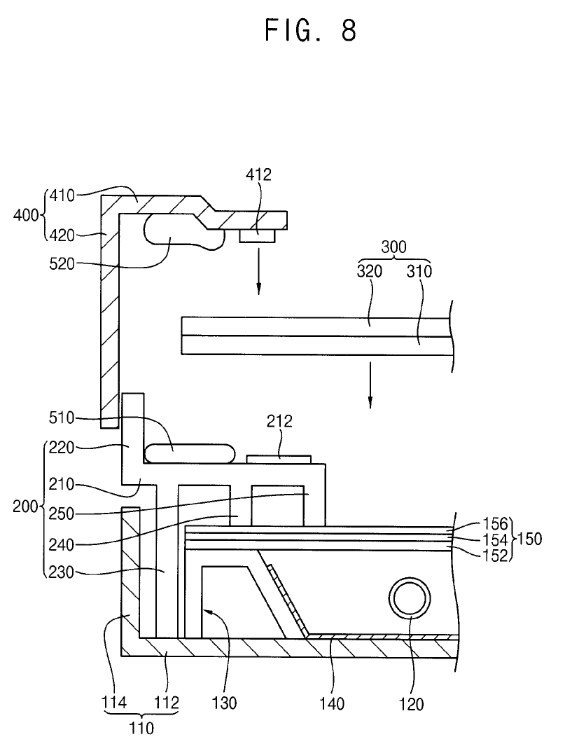

A display device shown in FIGS. 7 and 8 is substantially the same as the display device in FIGS. 1 to 4 except for at least a sealing member. Thus, identical reference numerals are used in FIGS. 7 and 8 to refer to components that are the same or like those shown in FIGS. 1 to 4, and thus, a detailed description thereof will be omitted.

FIG. 7 is a partial cross-sectional view illustrating another exemplary embodiment of a display device according to the present invention.

Referring to FIG. 7, a sealing member 500 is disposed between the mold frame 200 and the top chassis 400 to surround an end portion of the display panel 300. In the illustrated embodiment, the sealing member 500 includes a lower sealing part 510 and an upper sealing part 520.

The lower sealing part 510 is disposed to contact a first portion of an end portion of the display panel 300, and an edge portion of a lower surface of the display panel 300, the edge portion being opposite to and facing the mold bottom part 210. The upper sealing part 520 is disposed facing the lower sealing part 510, and is disposed contacting a second portion of the end portion of the display panel 300 and an edge portion of an upper surface of the display panel 300, the edge portion being opposite to an facing the chassis covering part 410. The lower sealing part 510 contacts to the upper sealing part 520, so that the lower and upper sealing parts 510 and 520 may be integrated with each other to collectively form the sealing member 500. The first and second portions of the end portion of the display panel 300 may form a whole of an end face, or the end portion, of the display panel 300.

The lower sealing part 510 is disposed between an end portion of the display panel 300 and the mold side wall 220, and between an edge portion of a lower surface of the display panel 300 and the mold bottom part 210. Thus, the lower sealing part 510 may fully seal a lower portion of a space between an end portion of the display panel 300 and the mold side part 220, and may fully seal a space between an edge portion of a lower surface of the display panel 300 and the mold bottom part 210.

The upper sealing part 520 is disposed between an end portion of the display panel 300 and the mold side wall 220, and between an edge portion of an upper surface of the display panel 300 and the chassis covering part 410. Thus, the upper sealing part 520 may fully seal an upper portion of a space between an end portion of the display panel 300 and the mold side part 220, and may fully seal a space between an edge portion of an upper surface of the display panel 300 and the chassis covering part 410.

In the illustrated embodiment, the collective sealing member 500 is disposed directly contacting both the edge portion of the upper surface and the edge portion of the lower surface of the display panel as shown in FIG. 7. In contrast, the sealing member 500 in FIG. 2 is disposed contacting only the edge portion of the lower surface of the display panel 300, and the sealing member in FIG. 5 is disposed contacting only the edge portion of the upper surface of the display panel 300. In each embodiment shown in FIGS. 2, 5 and 7, the sealing member directly contacts end faces of the first and second substrates 310 and 320 of the display panel 300.

The sealing member 500 may have elasticity, insulating properties and/or adsorption capacity for foreign matter such as external fine particles. In an exemplary embodiment, the sealing member 500 may include a silicon material and a plastic material having high elasticity, but the invention is not limited thereto.

Hereinafter, an exemplary embodiment of a method for manufacturing a display device of FIG. 7 will be described.

FIG. 8 is a cross-sectional view illustrating an exemplary embodiment of a process for manufacturing the display device of FIG. 7.

Referring to FIG. 8, the receiving container 110, the light-generating unit 120, the side mold 130, the reflective plate 140, the optical member 150 and the mold frame 200 are coupled with each other to manufacture the backlight assembly 100. The panel-supporting part 212 may be attached on a mold bottom part 210 of the mold frame 200.

The sealing member 500 is initially disposed on the mold bottom part 210 and the chassis covering part 410. The lower sealing part 510 is initially disposed on the mold bottom part 210, and the upper sealing part 520 is initially disposed on an inner side surface of the chassis covering part 410. The lower sealing part 510 is separately assembled with the backlight assembly 100, and the upper sealing part 520 is separately assembled with the top chassis 400, such that the two separate parts of the sealing member 500 are subsequently combined to form the final sealing member 500 of the display device DD.

The display panel 300 is disposed on the mold bottom part 210 as indicated by the downward pointing arrow below the display panel 300. The display panel 300 may be supported by the panel-supporting part 212 having elasticity.

The top chassis 400 is coupled with the receiving container 110, such as indicated by the downward pointing arrow below the chassis covering part 410, and fixes the display panel 300. The panel-pressing part 412 is attached on the chassis covering part 410 to press the display panel 300, so that damage to the display panel 300 may be reduced or effectively prevented.

When the top chassis 400 is coupled with the receiving container 110, the lower and upper sealing parts 510 and 520 may be formed to surround an end portion of the display panel 300. Both the lower and upper sealing parts 510 and 520 may be changed from their original shapes to conform to the profile of a space defined by the mold frame 200, the display panel 300 and the top chassis 400. The lower sealing part 510 may fully seal a lower portion of a space between an edge portion of the display panel 300 and the mold side part 220, and a space between an edge portion of a lower surface of the display panel 300 and the mold bottom part 210. The upper sealing part 520 may fully seal an upper portion of a space between an end portion of the display panel 300 and the mold side part 220, and a space between an edge portion of an upper surface of the display panel 300 and the chassis covering part 410.

In the illustrated embodiments of FIGS. 7 and 8, as the sealing member 500 fully seals a space between an end portion of the display panel 300 and the mold side part 220, a space between an edge portion of a lower surface of the display panel 300 and the mold bottom part 210, and a space between an edge portion of an upper surface of the display panel 300 and the chassis covering part 410, a flow of foreign matter such as fine particles may be reduced or effectively prevented from entering into the receiving container 110 through a space between an end portion of the display panel 300 and the mold side part 220.

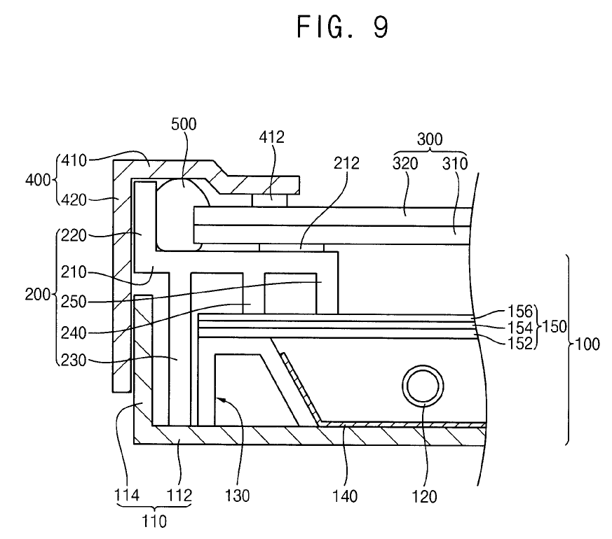

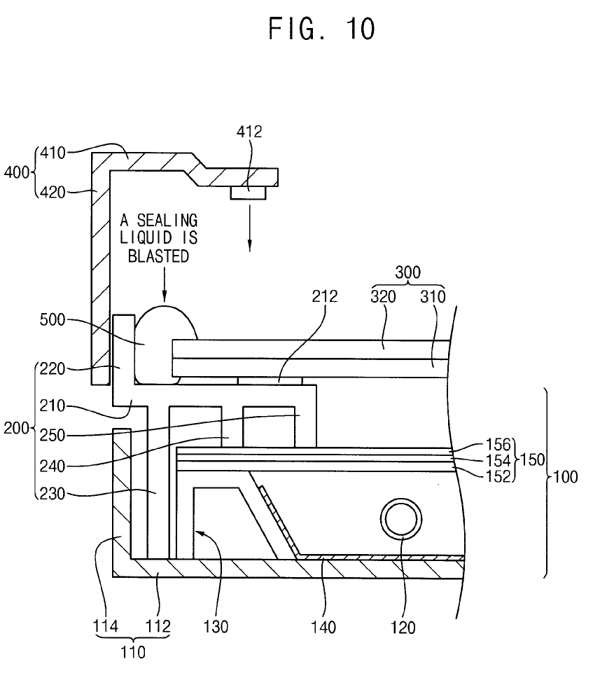

A display device in accordance with FIGS. 9 and 10 is substantially the same as the display device in FIGS. 1 to 4 except for at least a sealing member. Thus, identical reference numerals are used in FIGS. 9 and 10 to refer to components that are the same or like those shown in FIGS. 1 to 4, and thus, a detailed description thereof will be omitted.

FIG. 9 is a partial cross-sectional view illustrating another exemplary embodiment of a display device according to the present invention.

Referring to FIG. 9, a sealing member 500 is disposed between the mold frame 200 and the top chassis 400 to surround an end portion of the display panel 300. In the illustrated embodiment, the sealing member 500 may be disposed to contact an end portion of the display panel 300, an edge portion of an upper surface of the display panel 300, which is opposite to and facing the chassis covering part 410, and an edge portion of a lower surface of the display panel 300, which is opposite to and facing the mold bottom part 210.

The sealing member 500 is disposed between an end portion of the display panel 300 and the mold side wall 220, so that the sealing member 500 may fully seal a space between an end portion of the display 300 and the mold side part 220.

The sealing member 500 may also be disposed between both an edge portion of an upper surface of the display panel 300 and the chassis covering part 410, and an edge portion of a lower surface of the display panel 300 and the mold bottom part 210, so that the sealing member 500 may also fully seal a space between an edge portion of an upper surface of the display panel 300 and the chassis covering part 410, and an edge portion of a lower surface of the display panel 300 and the mold bottom part 210. As shown in FIG. 9, the sealing member 500 is a single, continuous and indivisible unit, and directly contacts both uppermost and lowermost surfaces of the display panel 300.

The sealing member 500 may have elasticity, insulating properties and/or adsorption capacity for foreign matter such as external fine particles. In an exemplary embodiment, the sealing member 500 may include a silicon material and a plastic material having high elasticity, but the invention is not limited thereto.

Hereinafter, an exemplary embodiment of a method for manufacturing a display device of FIG. 9 will be described.

FIG. 10 is a cross-sectional view illustrating an exemplary embodiment of a process for manufacturing the display device of FIG. 9.

Referring to FIG. 10, the receiving container 110, the light-generating unit 120, the side mold 130, the reflective plate 140, the optical member 150 and the mold frame 200 are coupled with each other to manufacture the backlight assembly 100. The panel-supporting part 212 may be attached on a mold bottom part 210 of the mold frame 200, such that the backlight assembly 100 including the panel-supporting part 212 is a separate and individual member of the display device.

The display panel 300 is disposed on the mold bottom part 210. The display panel 300 may be supported by the panel-supporting part 212 having elasticity, such that the backlight assembly 100 including the panel-supporting member 212 and the display panel 300, may be considered an intermediate assembly which is still separate from the sealing member 500 and the top chassis 400 before final assembling of the display device DD.

The sealing member 500 is disposed to surround an end portion of the display panel 300. In one exemplary embodiment, sealing liquids are disposed, such as by spraying, to seal a space between an end portion of the display panel 300 and the mold side part 220, and the sealing liquids are cured such that the final sealing member 500 may be formed. The sealing liquids may be sprayed to cover an edge portion of an upper surface of the display panel 300, as shown in FIG. 10. The sealing liquids may also be applied to contact an edge portion of a lower surface of the display panel 300, at the same time the sealing liquids contact the upper surface of the display panel 300. The sealing liquids may be maintained separated from the panel-supporting part 212 on the mode bottom part 210. The sealing liquids may have adhesive properties to allow relatively easy attachment to the display panel 300 and the mold frame 200.

The top chassis 400 is coupled with the receiving container 110 to fix the display panel 300. The panel-pressing part 412 is attached on the chassis covering part 410 to press the display panel 300, so that damage to the display panel 300 by external impacts may be reduced or effectively prevented.

When the top chassis 400 is coupled with the receiving container 110, the sealing member 500 may fully seal a space between an edge portion of the display panel 300 and the mold side part 220. Furthermore, the sealing member 500 may also fully seal a space between an edge portion of an upper surface of the display panel 300 and the chassis covering part 410.

In the illustrated embodiments of FIGS. 9 and 10, as the sealing member 500 fully seals a space between an end portion of the display panel 300 and the mold side part 220, fully seals a space between an edge portion of an upper surface of the display panel 300 and the chassis covering part 410, and/or fully seals a space between an edge portion of a lower surface of the display panel 300 and the mold bottom part 210, entry of foreign matter such as fine particles into the receiving container 110 through a space between an end portion of the display panel 300 and the mold side part 220 may be reduced or effectively prevented.

In the exemplary embodiments described above, a sealing member may fully seal a space between an end portion of a display panel and a mold side part. Moreover, the sealing member may fully seal a space between an edge portion of a lower surface of the display panel and a mold bottom part, and a space between an edge portion of an upper surface of the display panel and a chassis covering part.

Accordingly, the sealing member may reduce or effectively prevent foreign matter such as fine particles from flowing into a receiving container through a space between an end portion of the display panel and the mold side part. Advantageously, decrease of the display quality of the display device caused by foreign matter flowing into the display device may be reduced or effectively prevented.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A display device comprising:
a backlight assembly comprising a light-generating unit generating light, a receiving container receiving the light-generating unit, and a mold frame disposed along an edge portion of the receiving container;
a display panel disposed on the mold frame to display images by using the light;
a top chassis coupled with the receiving container, covering an edge portion of the display panel and fixing the display panel; and
a sealing member disposed between the mold frame and the top chassis and surrounding an end portion of the display panel, the sealing member fully sealing a space between the end portion of the display panel and the mold frame, and having elasticity, insulating properties and adsorption capacity for foreign matter.

2. The display device of claim 1, wherein the mold frame comprises:
a mold bottom part disposed substantially in parallel with a lower surface of the display panel facing the receiving container, the mold bottom part supporting the display panel; and
a mold side part extended from the mold bottom part and facing the end portion of the display panel.

3. The display device of claim 2, wherein the sealing member fully seals a space between the end portion of the display panel and the mold side part.

4. The display device of claim 3, wherein the sealing member contacts the end portion of the display panel and an edge portion of the lower surface of the display panel.

5. The display device of claim 3, wherein the sealing member contacts the end portion of the display panel and an edge portion of an upper surface of the display panel.

6. The display device of claim 3, wherein the sealing member contacts the end portion of the display panel, an edge portion of a lower surface of the display panel, and an edge portion of an upper surface of the display panel, the end portion of the display panel being directly adjacent to both the edge portion of the lower surface and the edge portion of the upper surface of the display panel.

7. The display device of claim 6, wherein the sealing member is a continuous member.

8. The display device of claim 6, wherein the sealing member comprises:
a lower sealing part contacting the end portion of the display panel and the edge portion of the lower surface of the display panel; and
an upper sealing part contacting the end portion of the display panel and the edge portion of the upper surface of the display panel.

9. The display device of claim 8, wherein the lower sealing part seals a space between the mold bottom part and the lower surface of the display panel, and
the upper sealing part seals a space between the top chassis and the upper surface of the display panel.

10. The display device of claim 1, wherein the sealing member comprises a silicon material.

11. The display device of claim 1, wherein the sealing member comprises a plastic material having high elasticity.

12. The display device of claim 1, further comprising a panel-supporting part disposed on the mold bottom part and contacting a lower surface of the display panel, the panel-supporting part having elasticity to support the display panel.

13. The display device of claim 1, further comprising a panel-pressing part disposed on an inner side surface of the top chassis, the panel-pressing part having elasticity and pressing the display panel.

14. The display device of claim 13, wherein the panel-pressing part comprises a conductive material emitting static electricity of the display panel.

15. A method of manufacturing a display device, the method comprising:
manufacturing a backlight assembly including a light-generating unit generating light, a receiving container receiving the light-generating unit and a mold frame disposed along an edge portion of the receiving container;
forming a sealing member on at least one of the mold frame and a top chassis which will be coupled to the receiving container;
disposing a display panel displaying images on the mold frame; and
coupling the top chassis and the receiving container, such that the sealing member surrounds an end portion of the display panel and fixes the top chassis to the display panel.

16. The method of claim 15, wherein the mold frame comprises:
a mold bottom part disposed substantially in parallel with a lower surface of the display panel facing the receiving container, the mold bottom part supporting the display panel; and
a mold side part extended from the mold bottom part and facing the end portion of the display panel,
the sealing member fully sealing a space between the end portion of the display panel and the mold side part after the top chassis is coupled to the receiving container.

17. The method of claim 16, wherein the forming a sealing member includes disposing the sealing member on the mold bottom part, the sealing member having a protruding shape protruded toward the top chassis and fully sealing a space between the end portion of the display panel and the mold side part.

18. The method of claim 16, wherein the forming a sealing member includes disposing the sealing member on an inner side surface of the top chassis, the sealing member having a protruding shape protruded toward the receiving container and fully sealing a space between the end portion of the display panel and the mold side part.

19. The method of claim 16, wherein the sealing member comprises:
a lower sealing part disposed on the mold bottom part; and
an upper sealing part disposed on an inner side surface of the top chassis to correspond with the lower sealing part.

20. A method of manufacturing a display device, the method comprising:
manufacturing a backlight assembly including a light-generating unit generating light, a receiving container receiving the light-generating unit and a mold frame disposed along an edge portion of the receiving container;
disposing a display panel displaying images on the mold frame;
forming a sealing member on the mold frame and surrounding an end portion of the display panel; and
coupling a top chassis and the receiving container to fix the display panel.

21. The display device of claim 20, wherein the mold frame comprises:
a mold bottom part disposed in parallel with a lower surface of the display panel facing the receiving container to support the display panel; and
a mold side part extended from the mold bottom part and facing the end portion of the display panel,
the sealing member fully sealing a space between the end portion of the display panel and the mold side part after the top chassis is coupled to the receiving container.
